(19) United States
(12) Patent Application Publication
(10) Pub. No.: US 2026/0352889 A1
(43) Pub. Date: Nov. 5, 2026

(54) EXTENDING VIDEO NAL UNITS FOR SEI MESSAGES

(71) Applicant: TENCENT AMERICA LLC, Palo Alto, CA (US)

(72) Inventors: Arianne HINDS, Los Gatos, CA (US); Stephan WENGER, San Jose, CA (US)

(73) Assignee: TENCENT AMERICA LLC, Palo Alto, CA (US)

(21) Appl. No.: 19/648,093

(22) Filed: Apr. 15, 2026

Related U.S. Application Data
(60) Provisional application No. 63/790,598, filed on Apr. 17, 2025.

(51) Int. Cl. H04N 19/70; H04N 19/169

(52) U.S. Cl. CPC H04N 19/70; H04N 19/188

(57) ABSTRACT

A method and apparatus comprising computer code configured to cause a processor or processors to obtain at least one first network abstraction layer (NAL) unit that comprises information of a decoding processing, identify a presence of a supplementary enhancement information (SEI) extension to the at least one first NAL unit; parse the at least one first NAL unit and the SEI extension, and, based on the SEI message, code video data.

### CROSS REFERENCE TO RELATED APPLICATION

This application claims priority to U.S. provisional application 63/790,598, filed on Apr. 17, 2025, the disclosure of which is incorporated herein by reference in its entirety.

### BACKGROUND

### 1. Field

The disclosed subject matter relates to video coding and decoding, and more specifically, to the delivery and scope of SEI messages in coded video bitstreams.

### 2. Description of Related Art

Video coding and decoding using inter-picture prediction with motion compensation has been known for decades. Uncompressed digital video can consist of a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

One purpose of video coding and decoding can be the reduction of redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

A video encoder and decoder can utilize techniques from several broad categories, including, for example, motion compensation, transform, quantization, and entropy coding, some of which will be introduced below.

But current cancel and persistence SEI options do not provide a mechanism to explicitly signal that an SEI message should apply to a clearly identified portion within the video bitstream.

### SUMMARY

There is provided a method for video decoding, the method performed by at least one processor and including: obtaining at least one first network abstraction layer (NAL) unit that comprises information of a decoding processing; identifying a presence of a supplementary enhancement information (SEI) extension to the at least one first NAL unit; parsing the at least one first NAL unit and the SEI extension; and based on the SEI extension, decoding video data.

There is provided a method for video encoding, the method performed by at least one processor and including: determining at least one first network abstraction layer (NAL) unit that comprises information of a decoding processing; adding a supplementary enhancement information (SEI) extension to the at least one first NAL unit; and based on the SEI extension, encoding video data.

There is provided a non-transitory computer-readable storage medium storing instructions and a video bitstream that are generated by a video encoding method, the instructions, when executed by a computer, cause the computer to implement a video encoding method including: determining at least one first network abstraction layer (NAL) unit that includes information of a decoding processing; adding a supplementary enhancement information (SEI) extension to the at least one first NAL unit; based on the SEI extension, encoding video data; and transmitting the video bitstream.

And of the above methods and storage medium storing instructions, the at least one first NAL unit may be one of a video usability information, a video parameter set, a sequence parameter set, a picture parameter set, and an adaptation parameter set.

And of the above methods and storage medium storing instructions, the SEI extension may include an SEI_rbsp( ) syntax.

And of the above methods and storage medium storing instructions, the SEI extension may be of one of a coded video stream and a coded layer video stream.

And of the above methods and storage medium storing instructions, the SEI extension may indicate at least one of a two-dimensional (2D) omnidirectional presentation and a 2D presentation.

And of the above methods and storage medium storing instructions, the SEI extension may indicate at least one of an interpretation of color and light and a picture capturing process.

And of the above methods and storage medium storing instructions, the SEI extension may indicate at least one of random access points and descriptions of a coded layer video stream.

### BRIEF DESCRIPTION OF THE DRAWINGS

Further features, nature, and various advantages of the disclosed subject matter will be more apparent from the following detailed description and the accompanying drawings in which:

FIG. 1 is a block diagram of a communication system in accordance with embodiments;

FIG. 2 is a block diagram of a video encoder and decoder in a video streaming environment in accordance with embodiments;

FIG. 3 is a block diagram of a video decoder in accordance with embodiments;

FIG. 4 is a block diagram of a video encoder in accordance with embodiments;

FIG. 5 is a schematic illustration of NAL unit and SEI headers in accordance with embodiments;

FIG. 6 is a schematic illustration of hierarchical layers of structures within an architecture of a video codec in accordance with embodiments;

FIG. 7 is a schematic illustration of hierarchical layers of structures within an architecture of a video codec in accordance with embodiments;

FIG. 8 is a schematic illustration of the logical organization of video structures to form other video structures accordance with embodiments;

FIG. 9 is a schematic illustration of a picture header NAL unit that references a picture parameter set NAL unit with a payload extension that includes SEI messages in accordance with embodiments;

FIG. 10 is a schematic illustration of a picture parameter set NAL unit that references a sequence parameter set with a payload extension that includes SEI messages in accordance with embodiments;

FIG. 11 is a schematic illustration of a sequence parameter set NAL unit that references a video parameter set with a payload extension that includes SEI messages in in accordance with embodiments;

FIG. 12 is a schematic illustration of video usability information NAL unit with a payload extension that includes SEI messages in accordance with embodiments; and

FIG. 13 is a simplified diagram of computer features in accordance with embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

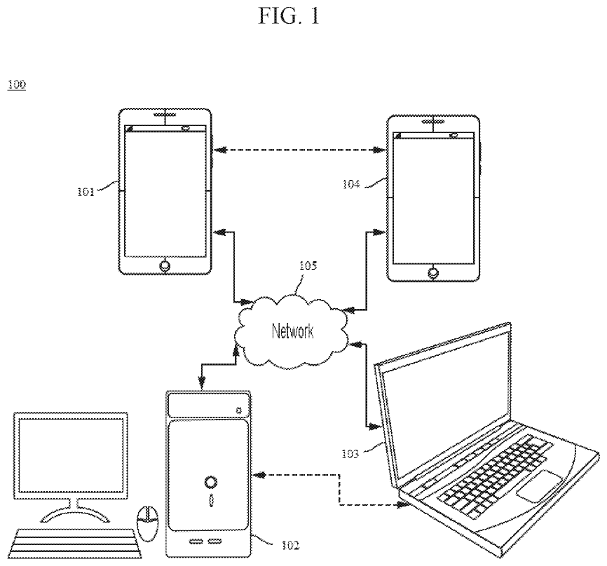

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. The network 105 may include Media Aware Network Elements (MANEs) that may be included in a transmission path between, for example, terminals 101 and 104. The purpose of a MANE may be selective forwarding of parts of the media data to react to network congestions, media switching, media mixing, archival, and similar tasks commonly performed by a service provided rather than an end user. Such MANEs may be able to parse and react on a limited part of the media conveyed over the network, for example syntax elements related to the network abstraction layer of video coding technologies or standards.

Representative networks include telecommunications networks, local area networks, wide area networks and/or the Internet. For the purposes of the present discussion, the architecture and topology of the network 105 may be immaterial to the operation of the present disclosure unless explained herein below.

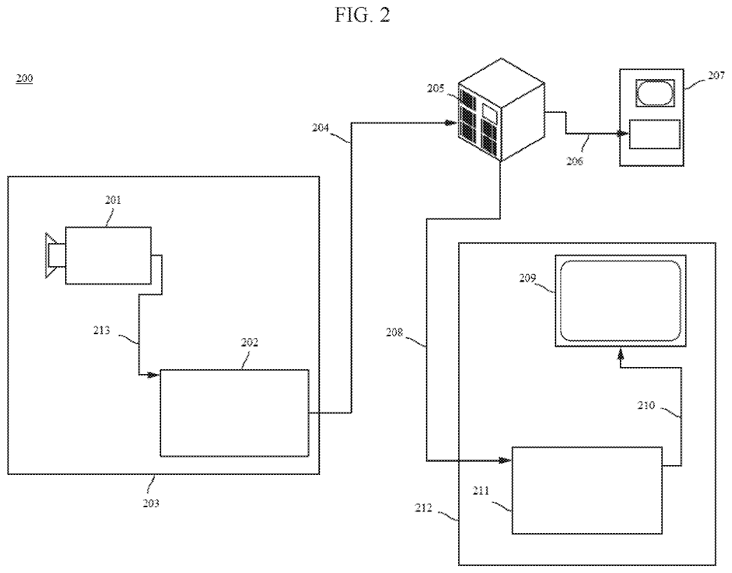

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the video source 201, which may be for example a camera as discussed above. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

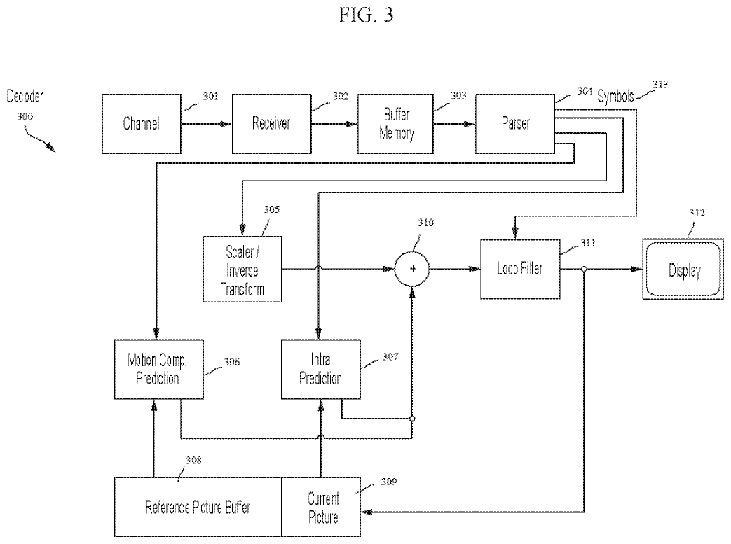

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information (VUI) parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In some cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the render device 312 as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

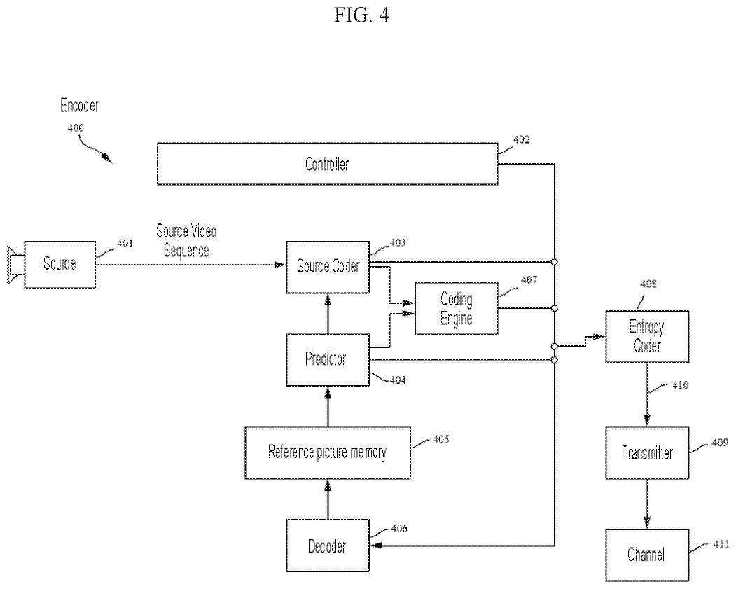

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder 400 (“source coder” henceforth) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture memory 405, which may be for example a cache. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the source coder 403, which may be for example a video coder, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the source coder 403 with other data to be transmitted, for example, coded audio data and/or ancillary data streams (sources not shown).

The controller 402 may manage operation of the encoder 400. During coding, the controller 402 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The encoder 400, which may be for example a video coder, may perform coding operations according to a predetermined video coding technology or standard, such as ITU-T Rec. H.265. In its operation, the encoder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

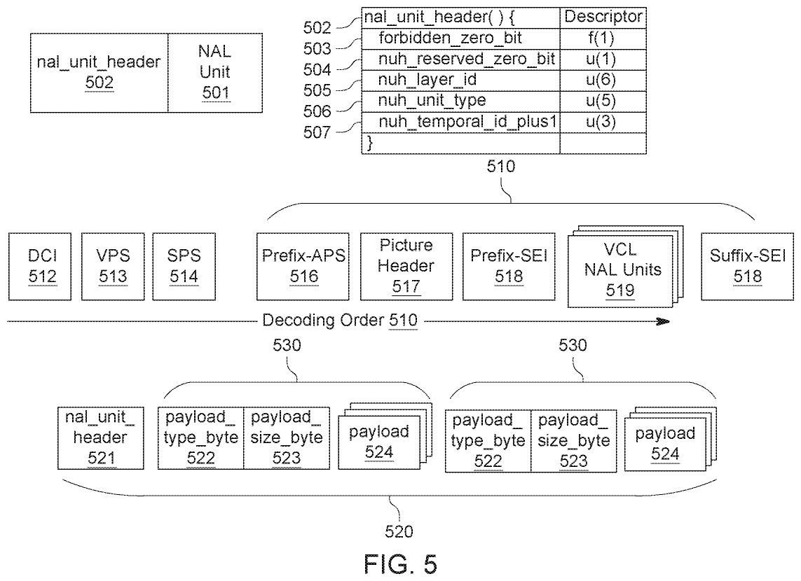

Referring to FIG. 5, shown is an exemplary layout of a Coded Video Sequence (CVS) in accordance with H.266. The coded video sequence is subdivided into Network Abstraction Layer units (NAL units). An exemplary NAL unit 501 can include a NAL unit header 502, which in turn comprises 16 bits as follows: a forbidden_zero_bit 503 and nuh_reserved_zero_bit 504 may be unused by H.266 and may be zero in a NAL unit. There is compliance with H.266. Three bits of nuh_layer_id 505 may be indicative of the (spatial, SNR, or multiview enhancement) layer to which the NAL unit belongs. Five bits of nuh_nal_unit_type define the type of NAL unit. In H.266, 22 NAL unit type values are defined for NAL unit types defined in H.266, six NAL unit types are reserved, and four NAL unit type values are unspecified and can be used by specifications other than H.266. Finally, three bits of the NAL unit header indicate the temporal layer to which the NAL unit belongs nuh_temporal_id_plus1 506.

A coded picture may contain one or more Video Coding Layer (VCL) NAL units and zero or more non-VCL NAL units. VCL NAL units may contain coded data conceptually belonging to a video coding layer as introduced before. Non-VCL NAL units may contain data conceptually belonging data not conceptually belonging to the video coding layer. Using H.266 as an example, they can be categorized into
(1) Parameter sets, which comprise information that can be necessary for the decoding process and can apply to more than one coded picture. Parameter sets and conceptually similar NAL units may be of NAL unit types such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.
(2) Picture Header (PH_NUT), which is also a “normative” NAL unit.
(3) NAL units marking certain places in a NAL unit stream. Those include NAL units with the NAL unit types AUD_NUT (Access Unit Delimiter), EOS_NUT (End of Sequence) and EOB_NUT (End of Bitstream). These are non-normative, also known as informative, in the sense that a compliant decoder does not require them for its decoding process, although it needs to be able to receive them in the NAL unit stream.
(4) Prefix and Suffix SEI NAL unit types (PREFIX_SEI_NUT and SUFFIX_SEI_NUT) which indicate NAL units containing Prefix and Suffix supplementary enhancement information. IN H.266, those NAL units are informative, as they are not required for the decoding process.
(5) Filler Data NAL unit type FD_NUT indicates filler data; data that can be random and can be used to “waste” bits in a NAL unit stream or bitstream, which may be necessary for the transport over certain isochronous transport environments.
(6) Reserved and Unspecified NAL unit types.

Still referring to FIG. 5, shown is a layout of a NAL unit stream in decoding order 510 containing a coded picture 511 containing NAL units of some of the types previously introduced. Somewhere early in the NAL unit stream, DCI 512, VPS 513, and SPS 514 may, in combination, establish the parameters which the decoder can use to decode the coded pictures of a coded video sequence (CVS), including coded picture (511) of the NAL unit stream.

The coded picture 511 can contain, in the depicted order or any other order compliant with the video coding technology or standard in use (here: H.266, according to one or more embodiments for example): a Prefix APS 516, Picture header (PH, 517), prefix SEI 518, one or more VCL NAL units 519, and suffix SEI 520.

Prefix and suffix SEI NAL units (18 and 520 were motivated from standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs allows avoiding buffering. As one example, in an encoder the sampling time of a picture to be coded is known before the picture is coded, and hence the picture timing SEI message can be a prefix SEI message 516. On the other hand, a decoded picture hash SEI message, which contains a hash of the sample values of a decoded pictures and can be useful, for example, to debug encoder implementations, is a suffix SEI message 518 as an encoder cannot calculate a hash over reconstructed samples before a picture has been coded. The location of Prefix and Suffix SEI NAL units may not be restricted to their position in the NAL unit stream. The phrase “Prefix” and “Suffix” may imply to what coded pictures or NAL units the Prefix/Suffix SEI message may pertain to, and the details of this applicability may be specified, for example in the semantics description of a given SEI message.

Still referring to FIG. 5, shown is a simplified syntax diagram of a NAL unit that contains a prefix or suffix SEI message 520. This syntax can be a container format for multiple SEI messages that can be carried in one NAL unit. Details of the extension mechanism for both payload size and payload type numbering range specified in H.266 are omitted here for clarity. As other NAL units, SEI NAL units start with a NAL unit header 521. The header is followed by one or more SEI messages; two are depicted (530, 531) and described henceforth. Each SEI message inside the SEI NAL unit may include an 8 bit payload_type_byte 522 which specifies one of 256 different SEI types (or extension indication); an 8 bit payload_size_byte 523 which specifies the number of bytes of the SEI payload (or the presence of an extension block), and payload_size-byte number minus 1 bytes of Payload 524. The syntax of the Payload 524 depends on the SEI message, it can be of any length between 0 and 254 bytes unless the extension mechanism is used, in which case the syntax would allow for unlimited payload sizes.

Described herein are techniques to signal the hierarchical layers of a coded video bitstream to which an SEI should remain relevant.

The High Level Syntax (HLS) of certain video codecs (e.g., AVC|H.264, HEVC H.265, and VVC|H.266) contains information that guides the decoding of the remaining bitstream from multiple syntax elements into individual picture samples. Such guiding information may not necessarily be available to the decoder at a time simultaneous to the delivery of the coded picture data to the decoder. Thus, the placement and availability of such guiding information within or for the bitstream can directly impact the speed and efficacy at which the decoder can reconstruct coded pictures. Syntax elements that carry such guiding information include, for example, header structures located in the bitstream; parameter sets that may be available in the bitstream or conveyed to the decoder through other means prior to the decoder receiving the coded picture data. Further within the coded video bitstream or conveyed by external means, but associated with the decoder's operation and specified in video coding technology specifications, may be information that's not necessary for the decoding process but helpful for the selection of parts of the bitstream to be decoded, rendering, or presentation of the reconstructed video bitstream. Such information can be included in syntax structures known, for example, as visual usability information (VUI) or Supplemental Enhancement Information (SEI).

Certain video codecs such as, for example, MPEG-2 visual, use a hierarchy of transient headers, including a sequence header, group of picture (GOP-) header, picture header, and slice header. Syntax elements included in each header pertain to all underlying syntax structures. For example, syntax elements of the sequence header pertain to all GOPs included in the sequence, all pictures included in those GOPs, and all slices included in those pictures. Syntax elements of the GOP header pertain to all pictures included in the GOP, and all slices in the pictures. Such a hierarchical structure can lead to efficient coding but suboptimal error resilience properties. For example, if the vital information of a sequence header is lost in transmission, none of the GOPs, pictures, or slices of the sequence can be decoded.

Certain ITU and MPEG video codecs from 2003 onwards, namely AVC|H.264 and HEVC|H.265, do not use transient headers above the slice header. Instead, they rely on parameter sets. On each syntactical level, such as sequence or picture level, one or more parameter sets may be received by the decoder from the bitstream or by external means. Which of these (potentially many) parameter sets of the same type are being used for the decoding of a given sequence or picture depends on the reference coded in, for example, the slice header (i.e., to reference a picture parameter set, PPS) or the PPS (i.e., to reference a sequence parameter set, SPS). This architecture can have the advantage that the relevant parameter sets can be reliably sent even if the bitstream itself is sent over a lossy channel, or that the likelihood of their reception can be increased through the sending of redundant copies, potentially well in advance of their first use. One disadvantage can be that the sending of a parameter set can be more costly, in terms of bits required for the same number and types of syntax elements, than the sending of MPEG-2 style headers. Further, certain syntax elements that change frequently from picture to picture but stay constant within a given picture may, under this architecture, be included in the form of multiple redundant copies in each slice header. While doing so can make the slices independently decodable (at least from a parsing dependency end entropy decoding viewpoint), it can cost further bits. For this reason, HEVC included Adaptation Parameter Sets, and certain recent proposals discuss partial parameter set updates.

Parameter sets may not necessarily be delivered simultaneously with the delivery of coded picture data to a decoder process. They may instead be delivered by an external means (for example, through external configuration parameters provided to a decoder process) or by parameter sets that are delivered to the decoder from within the bitstream but asynchronously from the delivery of the coded picture data itself. Thus information that may be essential for a decoding process (to reconstruct picture samples) may be delivered asynchronously from the coded picture data itself.

Guiding information for the decoder also exists in the HEVC|H.265 and VVC|H.266 video codecs in the form of the Video Usability Information (VUI) syntax element. The VUI carries supplemental information pertaining to a coded video sequence, but when available, may also be provided asynchronously to the coded picture data. The VUI may be conceptually independent from sequence level parameters required for decoding, but may be nevertheless part of the sequence parameter set (SPS) for convenience.

Another technique used to carry guiding information in video coding standards is the Supplemental Enhancement Information (SEI) message which enables the carriage of supplemental information, within the coded bitstream. SEI messages as originally designed in the context of AVC|H.264 had, in certain cases, a scope of the information carried within the message to be relevant to the picture they were included in or associated with. The design of certain newer SEI messages accommodates the need, in some cases, to repeat the same SEI message for multiple pictures. Thus a cancel option and a persistence option were added in certain SEI messages to enable the signaling of an implied beginning and implied end of the relevance (or scope) for each SEI message, i.e., in terms of its relevance on portions of the video bitstream. However, these cancel and persistence options do not explicitly associate an SEI message with a precise scope in terms of the hierarchical structure of the coded bitstream.

Rather, the persistence option may be regarded as a simple signal to the decoder to create a “start” boundary of the coded picture data for which the SEI message should apply, i.e., be regarded as relevant. Similarly, the cancel option may be regarded as a signal to the decoder to establish an “end” boundary of the coded picture data for which the SEI message is relevant. Additional semantics for the persistence option include encountering the end of the coded video stream (CVS) or coded layer video stream (CLVS): i.e., when the CVS or CLVS ends, the decoder should regard the SEI information as “no longer relevant.”

To explicitly cancel the persistence of an SEI message that is currently relevant, the encoder may encode another instance of the active SEI message, but in this subsequent SEI message instance, with the “cancel” option flag enabled. When the decoder recognizes that the cancel option, of a previously encountered SEI message, is enabled, then the previous instance of that SEI is regarded as no longer relevant.

HEVC|H.265 and VVC|H.266 support a set of SEI messages with increased variety and purposes. Many in this set exist to support a particular purpose (e.g., neural-network post filtering) and in some cases, an application, e.g., Omnidirectional MediA Format (OMAF).

Further, certain SEI messages in this set may be specified separately from the core video coding specification in the Versatile Supplemental Enhancement Information (VSEI) messages for coded video bitstreams, which may contain specifications of SEI messages applicable to multiple video coding standards or technologies. Still others may be specified in application specific standards, e.g. video-based point cloud compression (V-PCC) or ISO/IEC 23090-5.

Across the set of SEI messages, the purpose, and the corresponding scope (for which the information may be applied in the coded picture data) may be inferred by the type of information present in the message payload, or by the semantics expressed for the syntax elements. Nevertheless, a single SEI message may be relevant to the entire bitstream for one application, and for another application, the same SEI message may be relevant to only a portion of the bitstream.

To refine the concept of the “scope” of the layers within a video structure hierarchy, the following ordered hierarchy, i.e., from the broadest scope (the highest level in the hierarchy) to the most constrained scope (the lowest level in the hierarchy) may be considered:
the entire bitstream the highest level; therefore, the start of the bitstream is implicit with the processing of the first NAL unit and hence there may be no need for an explicit NAL unit to signal the start of the bitstream;
followed by the coded video sequence (CVS); a coded video sequence start (CVSS) access unit (AU) may signal the start of a CVS;
followed by the coded layer video sequence (CLVS), which can be organized into one or more output layer set(s) (OLS); a coded layer video start sequence (CLVSS) picture unit (PU) may signal the start of a CLVS;
followed by the picture; the picture header non-VCL NAL unit may signal the start of a coded picture, and/or the start of a new picture can be inferred to by parsing and interpreting certain fields in the slice header if a picture header NAL unit is not present;
followed by the subpicture; there may be no explicit signaling of the start of a subpicture;
however, the start of a new subpicture can be inferred to by parsing and interpreting certain fields in the slice header;
followed by the slice; a slice header may signal the start of a slice;
followed by the coded unit (CU) which is the most constrained, i.e., “smallest”, in the hierarchy.

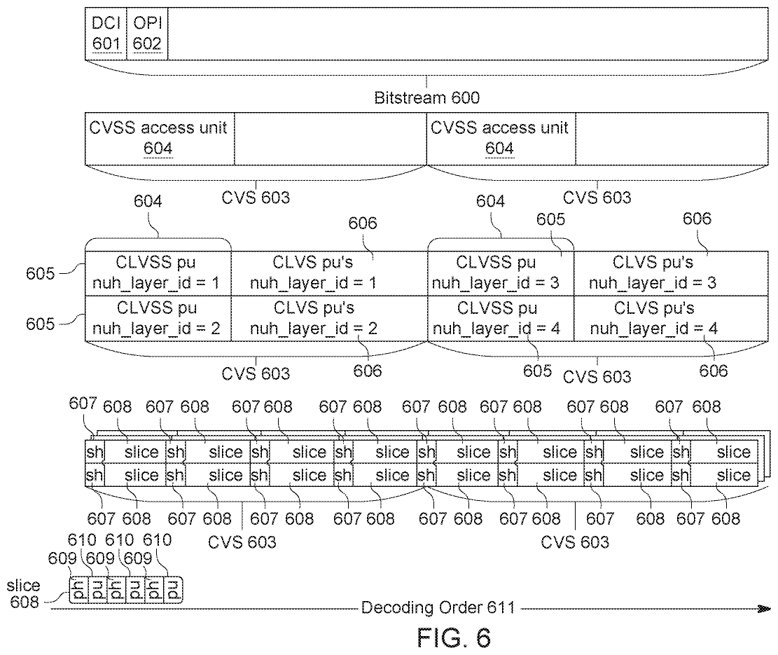

Referring to FIG. 6, shown is the first of two schematic illustrations of hierarchical layers of structures within an architecture of a video codec in accordance with VVC|H.266. Video bitstream 600 denotes a bitstream of video data, the beginning of which may be inferred by informative Decoder Capability Information NAL_UNIT 601 and/or informative Operating Point Information NAL_UNIT 602. Bitstream 600 is further decomposed into two Coded Video Stream (CVS) structures 603. The start of each CVS 603 may be signaled by CVS Start (CVSS) access unit 604. As depicted in FIG. 6, Each CVSS 604 is comprised of two Coded Layer Video Sequence Start (CLVSS) picture units 605.

Each CVS 603 is further decomposed into two streams of picture units (PU's), each of such stream is differentiated by nuh_layer_id. The start for stream of PUs corresponding to nuh_layer_id=1 may be signalled by CLVSS PU 605 with nuh_layer_id=1. CLVSS PU 605 with nuh_layer_id=1 may be followed by CLVS PUs 606 (there may one or more PUs in CLVS PU's 606) with nuh_layer_id=1 in decoding order 611. The start of CLVSS PU 605 with nuh_layer_id=3 follows the CLVS PU's 606 with nuh_layer_id=1 in decoding order 611. CLVS PU's 606 with nuh_layer_id=3 follows CLVSS PU 605 with nuh_layer_id=3. Simultaneous to the decoding of PUs corresponding to nuh_layer_id=1, the start of a series of PUs with nuh_layer_id=2 may be decoded or the same series of PUs with nuh_layer_id=2 may be decoded asynchronously to the series of PUs with nuh_layer_id=1. CLVSS 605 with nuh_layer_id=2 signals the start of a stream of PUs with nuh_layer_id=2. Following CLVSS 605 with nuh_layer_id=2, one or more CLVS PUs 606 with nuh_layer_id=2 is depicted in decoding order 611. Following the sequence of CLVS PUs 606 with nuh_layer_id=2 is another sequence of Pus with nuh_layer_id=4 in decoding order 611. CLVSS PU 605 with nuh_layer_id=4 denotes the start of PUs with nuh_layer_id=4. One or more CLVS PUs 606 with nuh_layer_id=4 follows CLVSS PU 605 with nuh_layer_id=4.

Still referring to FIG. 6, each of the PU's in each of CVS's 603 is further decomposed to illustrate that each PU is comprised of one or more of a Slice Header 607 followed by a Slice 608. Each slice 608 is further decomposed into a sequence of optional Picture Header's 609 in which each PH 609 is followed by a single Picture Unit (PU) 610.

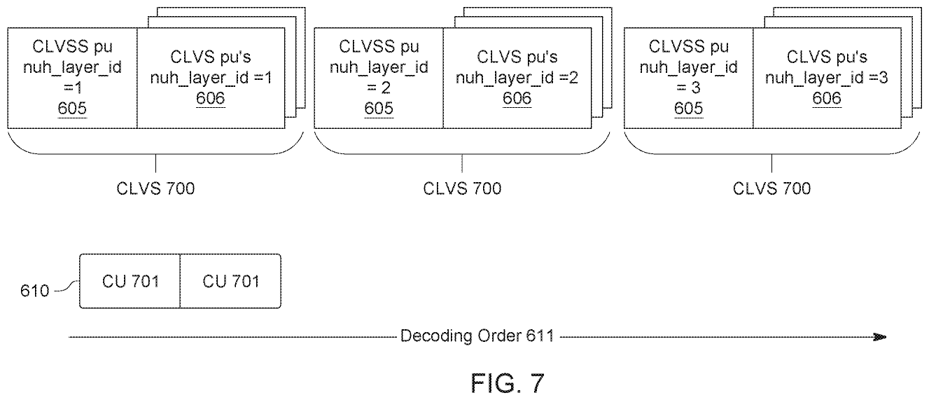

FIG. 7 is the second of the two figures to the illustrate the hierarchical structure of a video bitstream 600. In FIG. 7, three Coded Layer Video Streams (CLVS's) 700 are depicted, each with a unique nuh_layer_id. CLVS 700 with nuh_layer_id=1 is comprised of CLVSS 605 with nuh_layer_id=1 and one or more CLVS PU's 606 with nuh_layer_id=1 in decoding order 611.

Likewise, CLVS 700 with nuh_layer_id=2 is comprised of CLVSS 605 with nuh_layer_id=2 and one or more CLVS PU's 606 with nuh_layer_id=2 in decoding order 611. Finally, CLVS 700 with nuh_layer_id=3 is comprised of CLVSS 605 with nuh_layer_id=3 and one or more CLVS PU's 606 with nuh_layer_id=3 in decoding order 611.

FIG. 7 also illustrates that each PU 610 is comprised of a series of Coded Units 701.

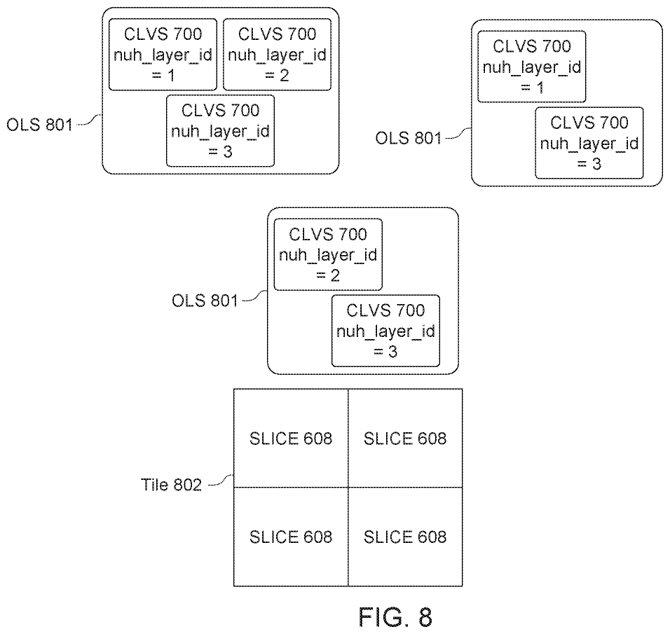

FIG. 8 depicts the logical organization of some of the hierarchical structures to create other video structures. In the figure, three Output Layer Sets 801 are depicted. One OLS 801 is comprised of three CLVSs, 700 i.e., one CLVS 700 with nuh_layer_id=1, one CLVS 700 with nuh_layer_id=2, and one CLVS 700 with nuh_layer_id=3. A second OLS 801 is comprised of one CLVS 700 with nuh_layer_id=1 and one CLVS 700 with nuh_layer_id=3. A third OLS 801 is depicted in which this OLS 801 is comprised of one CLVS 700 with nuh_layer_id=2 and one CLVS 700 with nuh_layer_id=3.

Also depicted in FIG. 8 is a single Tile 802 which is comprised of four adjacent Slice 608 structures to form a rectangular area within a picture.

A set of specific examples of SEIs for which the relevant scope may not be explicitly signaled, but for which the scope or purpose of the information carried within the payload may be inferred is provided in the Table 1 below:

TABLE 1
Table 1: SEIs with purpose and scope (either
inferred or explicitly specified).

| Name | Scope | Inferred purpose |
|---|---|---|
| Generalized cubemap projection SEI | CLVS | 2D omnidirectional |
| | | presentation |
| Sphere rotation | CLVS | 2D omnidirectional |
| | | presentation |
| Region-wise packing SEI | CLVS | 2D omnidirectional |
| | | presentation |
| Omnidirectional viewport SEI | CLVS | 2D omnidirectional |
| | | presentation |
| Frame packing arrangement SEI | CLVS | 2D presentation |
| Sample aspect ratio SEI | CLVS | 2D presentation |
| Annotated regions SEI | CLVS | 2D presentation |
| Display orientation SEI | CLVS | 2D presentation |
| Phase indication SEI | CLVS | 2D presentation |
| Colour transform information | CLVS | Interpretation of |
| SEI | | colour and light |
| Mastering display colour | CLVS | Interpretation of |
| volume SEI | | colour and light |
| Content light level | CLVS | Interpretation of |
| information SEI | | colour and light |
| Alternative transfer | CLVS | Interpretation of |
| characteristics SEI | | colour and light |
| Ambient viewing environment | CLVS | Interpretation of |
| SEI | | colour and light |
| Content colour volume SEI | CLVS | Interpretation of |
| | | colour and light |
| Shutter interval information | CLVS | Interpretation of |
| SEI | | colour and light |
| Image format metadata SEI | CLVS | Picture capturing |
| | | process |
| Constrained RASL SEI | CVS | Random access points |
| Dependent random access point SEI | picture | Random access points |
| Extended DRAP indication SEI | picture | Random access points |
| Scalable nesting SEI | CLVS | Description of CLVS |
| Parameter sets inclusion | CLVS | Description of CLVS |
| indication SEI | | |
| Depth representation information | CLVS | Description of CLVS |
| Alpha channel information SEI | CLVS | Description of CLVS |
| Source picture timing SEI | CLVS | Description of CLVS |
| Object mask information SEI | CLVS | Description of CLVS |
| Text description information SEI | CLVS | Description of CLVS |

RASL being random access skipped leading, and DRAP being dependent random access point.

The scope for each SEI in Table 1 may be mapped to some of the structures depicted in FIG. 6 and FIG. 7. Likewise, existing parameter sets in the HLS signalled with non-vel NAL unit may also have scopes that are inferred to correspond to the scopes of the SEIs in Table 1. That is, a Video Usability Information (VUI) NAL unit may be regarded as having a scope that pertains to the entire bitstream 600. A Video Parameter Set (VPS) NAL unit may be regarded as having a scope that pertains to a CVS 603. A Sequence Parameter Set (SPS) NAL unit may be regarded as having a scope that pertains to CLVS 700. Finally, a Picture Parameter Set (PPS) NAL unit may be regarded as having a scope that pertains to a Slice 608.

By extending the aforementioned existing HLS NAL units with a payload to carry the SEIs that are relevant to the scopes of the corresponding HLS NAL unit, the scope and persistence of the SEIs are more clearly defined to the receiving system including the decoder, renderer, or other entities responsive to the content of SEI messages.

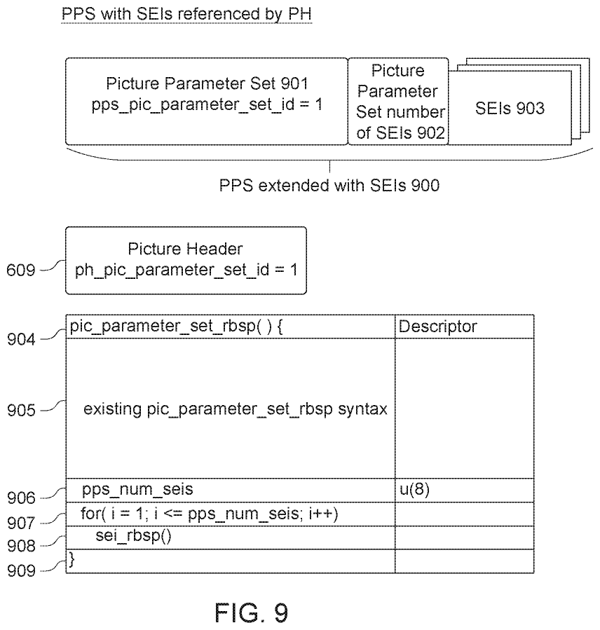

FIG. 9 depicts such an extended Picture Parameter Set 900. Extended PPS 900 is comprised of the PPS 901 with pps_pic_parameter_set_id=1. As depicted in FIG. 9, a count 902 of the number of SEI messages 903 that create the SEI extension for the PPS may be provided. The syntax for such an extended PPS 900 may be illustrated starting at line 904 of the syntax table for pic_parameter_set_rbsp( ). Line 905 illustrates that the existing syntax for the pic_parameter_set_rbsp may be unchanged. Following the existing rbsp at 905, a count for the number of SEIs in the payload extension of the PPS is depicted at line 906 as pps_num_seis. Line 907 in the depicted syntax illustrates that an iteration loop may be implemented for each in the count of pps_num_seis. For each iteration of loop 907, the sei_rbsp( ) may be executed at line 908. Line 909 depicts the end of the extended pic_parameter_set_rbsp( ) function. If the sei_rbsp( ) already allows multiple SEI payloads, then the loop may not be needed, and the syntax element pps_num_seis may be implemented as a flag indicative of the presence of a single sei_rbsp. However, to preserve byte alignment, that flag may also be coded as an 8 bit integer. Alternatively or in addition, the 8 bit integer may be indicative of the number of SEIs in the single sei_rbsp that is being appended to the PPS.

To illustrate the usage of such an extended PPS 900 with pps_pic_parameter_set_id=1, Picture Header 609 with ph_pic_parameter_set_id=1 is depicted in FIG. 9.

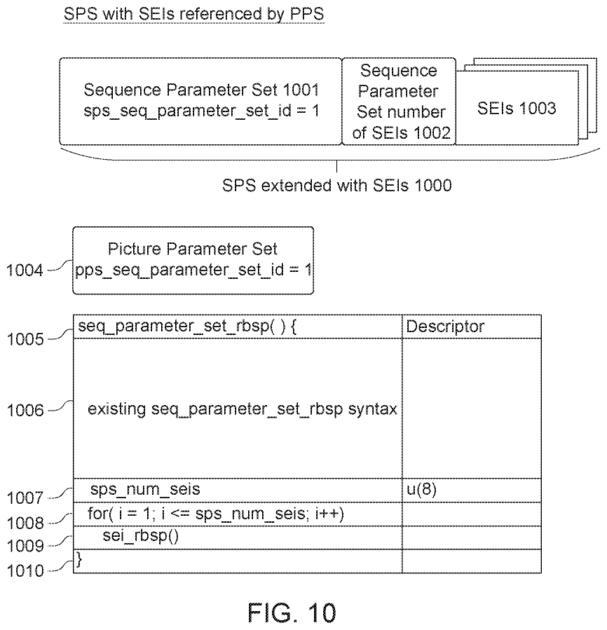

FIG. 10 depicts a PPS 1004 (which may or may not have an extended SEI payload) that references a Sequence Parameter Set 1000 that is extended with an SEI payload. Extended SPS 1000 is comprised of a non-extended SPS 1001 with an sps_sequence_parameter_set_id=1. A count of the number of SEIs in the SPS SEI payload extension is depicted as Sequence Parameter Set number of SEIs 1002. The set of SEIs that comprise the SEI payload extension is depicted SEIs 1003.

The syntax for such an extended SPS 1000 may be illustrated starting at line 1005 of the syntax table for seq_parameter_set_rbsp( ). Line 1006 illustrates that the existing syntax for the seq_parameter_set_rbsp may be unchanged. Following the existing rbsp at 1006, a count for the number of SEIs in the payload extension of the SPS is depicted at line 1007 as sps_num_seis.

Line 1008 in the depicted syntax illustrates that a iteration loop may be implemented for each in the count of sps_num_seis. For each iteration of loop 1008, the sei_rbsp( ) may be executed at line 1009. Line 1010 depicts the end of the extended sps_parameter_set_rbsp( ) function. The observation and techniques related to scenarios where multiple SEIs may be included in a single sei_rbsp described above may apply here similarly.

To illustrate the usage of such an extended SPS 1000 with sps_seq_parameter_set_id=1, Picture Parameter Set 1004 with pps_seq_parameter_set_id=1 is depicted in FIG. 10.

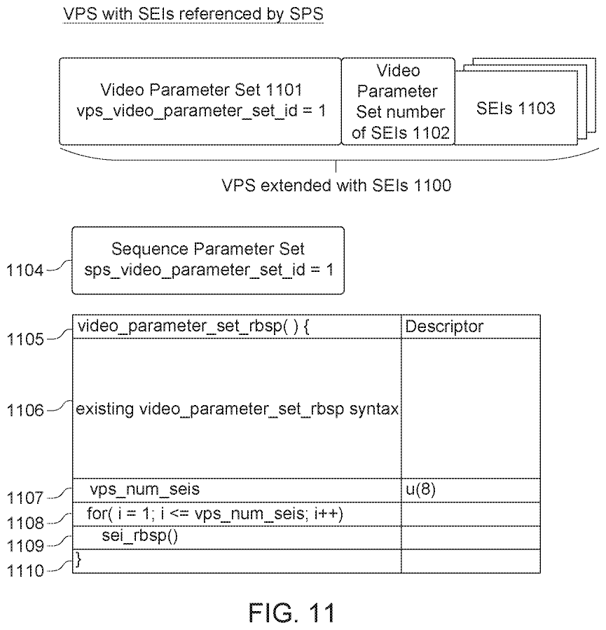

FIG. 11 depicts a SPS 1104 (which may or may not have an extended SEI payload) that references a Video Parameter Set 1100 that is extended with an SEI payload. Extended VPS 1100 is comprised of a non-extended VPS 1101 with an vps_video_parameter_set_id=1. A count of the number of SEIs in the VPS SEI payload extension is depicted as Video Parameter Set number of SEIs 1102. The set of SEIs that comprise the SEI payload extension is depicted SEIs 1103.

The syntax for such an extended VPS 1100 may be illustrated starting at line 1105 of the syntax table for video_parameter_set_rbsp( ). Line 1106 illustrates that the existing syntax for the video_parameter_set_rbsp may be unchanged. Following the existing rbsp at 1106, a count for the number of SEIs in the payload extension of the VPS is depicted at line 1107 as vps_num_seis. Line 1108 in the depicted syntax illustrates that a iteration loop may be implemented for each in the count of vps_num_seis. For each iteration of loop 1108, the sei_rbsp( ) may be executed at line 1109. Line 1110 depicts the end of the extended vps_parameter_set_rbsp( ) function.

To illustrate the usage of such an extended VPS 1100 with sps_video_parameter_set_id=1, Sequence Parameter Set 1104 with sps_video_parameter_set_id=1 is depicted in FIG. 11. The observation and techniques related to scenarios where multiple SEIs may be included in a single sei_rbsp described above may apply here similarly.

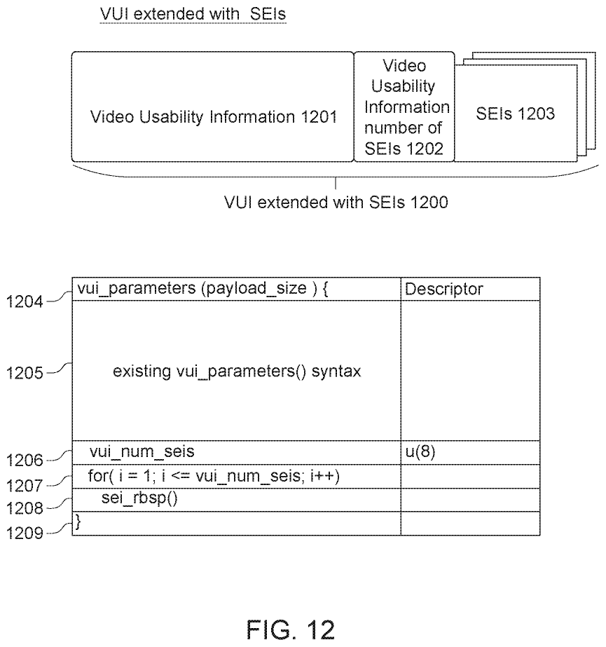

Similar to extended PPS 900, extended SPS 1000, and extended VPS 1100, the Video Usability Information NAL unit may likewise be extended as depicted in FIG. 12. Shown in FIG. 12 is extended VUI 1200 with is comprised of the non-extended VUI 1201, a count of the number of SEIs that create the SEI payload extension as video usability information number of SEIs 1202, and the SEI payload for the VUI 1203.

The syntax for such an extended VUI 1200 may be illustrated starting at line 1204 of the syntax table for vui_parameters(payload_size). Line 1205 illustrates that the existing syntax for the vui_parameters( ) may be unchanged. Following the existing vui_parameters at 1205, a count for the number of SEIs in the payload extension of the VUI is depicted at line 1206 as vui_num_seis. Line 1207 in the depicted syntax illustrates that a iteration loop may be implemented for each in the count of vui_num_seis. For each iteration of loop 1207, the sei_rbsp( ) may be executed at line 1209. Line 1210 depicts the end of the extended vui_parameters( ) function. The observation and techniques related to scenarios where multiple SEIs may be included in a single sei_rbsp described above may apply here similarly.

As such, there is provided a method for decoding a coded video bitstream in a decoder including parsing at least one first NAL unit that includes information required by the decoding process for at least one NAL units of a given syntactical scope; identifying the presence of an SEI extension; and parsing of the SEI extension if its presence was identified. And the first NAL unit may be one of a set of Video Usability Information, Video Parameter Set, Sequence Parameter Set, Picture Parameter Set, and Adaptation Parameter Set, or other NAL unit types. And the SEI extension may include an SEI_rbsp( ).

According to embodiments, an SEI syntax may regard a versatile SEI raw byte sequence payload (RBSP) such as:

```
vsei_rbsp( ) {
  vsei_position
  vsei_relevance
  vsei_payload_size_length
  vsei_reserved
  do
    versatile_sei_message( )
  while ( vsei_payload_size_length&&more_rbsp_data( ) )
  rbsp_trailing_bits( )
}
```

Versatile supplemental enhancement information RBSP contains information that is not necessary to decode the samples of coded pictures from VCL NAL units. A VSEI RBSP contains one or more VSEI message.

vsei_position indicates if the SEI message corresponds to the PREFIX_SEI_NUT and SUFFIX_SEI_NUT. vsei_position equal 0 indicates that the SEI message is treated as PREFIX_SEI_NUT. vsei_position equal 1 indicates that the SEI message is treated as SUFFIX_SEI_NUT. Values 3 and 4 of vsei_position are reserved for future use and shall be ignored.

vsei_relevance indicates the relevance of the SEI message for the target application. vsei_relevance ranges from 0 to 3, with 0 being the least relevant and 3 being the most relevant. vsei_relevance equal to 3 indicates that the versatile SEI message may be a required versatile SEI message.

vsei_payload_size_flag length equal to 0 specifies that no vsei_payload_size_16 bits syntax element is present in vsei_rbsp( ) the versatile SEI message. vsei_payload_size_flag length not equal to 01 specifies that one or more vsei_payload_size_16 bits syntax elements are present in vsei_rbsp( ) the SEI message. When vsei_payload_size_flag is equal to 0, the SEI message shall be the only SEI message in the NAL unit. NOTE—When vsei_payload_size_length is equal to 0, the NAL unit contains only one SEI message.

vsei_reserved is reserved for future use and shall be ignored.

```
    A versatile SEI message syntax may be
versatile_sei_message ( ) {
  vseiPayloadType = 0
  do {
    vsei_payload_type_byte
    vseiPayloadType+=vsei_payload_type_byte
  } while (vsei_payload_type_byte = =0xFF)
  if (vsei_payload_size_length )
    vsei_payload_size
  vsei_payload (vsei_Payload_Type, vsei_payload_size)
  }
```

Each versatile SEI message consists of the variables specifying the payload type and payload size of the SEI message payload. NOTE—The NAL unit byte sequence containing the SEI message might include one or more emulation prevention bytes (represented by emulation_prevention_three_byte syntax elements).

vsei_payload_type_byte is a byte of the payload type of a versatile SEI message.

vsei_payload_size specifies the payload size in bytes of a versatile SEI message. The length of the syntax element is 8*vsei_payload_size_length bits. When vsei_payload_size_16 bits is not present, it is inferred to be equal to NumBytesInNalUnit−4.

```
    An example SEI message without an ID syntax may be in a format of
example (payloadSize){
  ex_persistence_idc
  if(ex_persistence_idc > 0 ){
  /*additional syntax elements*/
  }
}
```

An example SEI message without an ID semantics may regard

ex_persistence_idc specifies the persistence of the example SEI message for the current layer. ex_persistence_idc equal to 0 indicates that the example SEI message cancels the persistence of any previous example SEI message in output order that applies to the current layer of the current example SEI message.

ex_persistence_idc equal to 1 specifies that the example SEI message applies to the current decoded picture only.

ex_persistence_idc equal to 2 specifies that the example SEI message applies to the current decoded picture and persists for all subsequent pictures of the current layer in output order until one or more of the following conditions are true:
A new CLVS of the current layer begins.
The bitstream ends.
A picture in the current layer in an AU associated with an example SEI message that follows the current picture in output order.

ex_persistence_idc equal to 3 specifies that the example SEI message applies for the entire CLVS.

It is a requirement of bitstream conformance that when ex_persistence_idc is equal to 3 and this SEI message is not the first example SEI message in a CLVS, in decoding order, an example SEI message shall be present in the first PU of the CLVS in decoding order. When ex_persistence_idc is equal to 3 in the first PU in the CLVS in decoding order, all example SEI messages in the CLVS shall have identical SEI payload content.

```
    An example SEI message with an ID syntax may be in a format of
example( payloadSize){
  ex_id
  ex_persistence_idc
  if(ex_persistence_idc >0 ){
  /*additional syntax elements*/
  }
}
```

An example SEI message with an ID semantics may be of

ex_id specifies an identifier of the example SEI message.

ex_persistence_idc specifies the persistence of the example SEI message for the current layer.

ex_persistence_idc equal to 0 indicates that the example SEI message cancels the persistence of any previous example SEI message in output order that applies to the current layer and has the same ex_id as the current example SEI message.

ex_persistence_idc equal to 1 specifies that the example SEI message applies to the current decoded picture only.

ex_persistence_idc equal to 2 specifies that the example SEI message applies to the current decoded picture and persists for all subsequent pictures of the current layer in output order until one or more of the following conditions are true:
A new CLVS of the current layer begins.
The bitstream ends.
A picture in the current layer in an AU associated with an example SEI message with the same ex_id is output that follows the current picture in output order.

ex_persistence_idc equal to 3 specifies that the example SEI message applies for the entire CLVS. It is a requirement of bitstream conformance that when ex_persistence_idc is equal to 3 and this SEI message is not the first example SEI message in a CLVS, in decoding order, an example SEI message with the same value of ex_id shall be present in the first PU of the CLVS in decoding order.

All example SEI messages in a CLVS that have a particular ex_id value and ex_persistence_idc equal to 3 shall have identical SEI payload content.

When ex_persistence_idc is equal to 3 in the first PU in the CLVS in decoding order, all example SEI messages in the CLVS that have a particular ex_id value shall have identical SEI payload content.

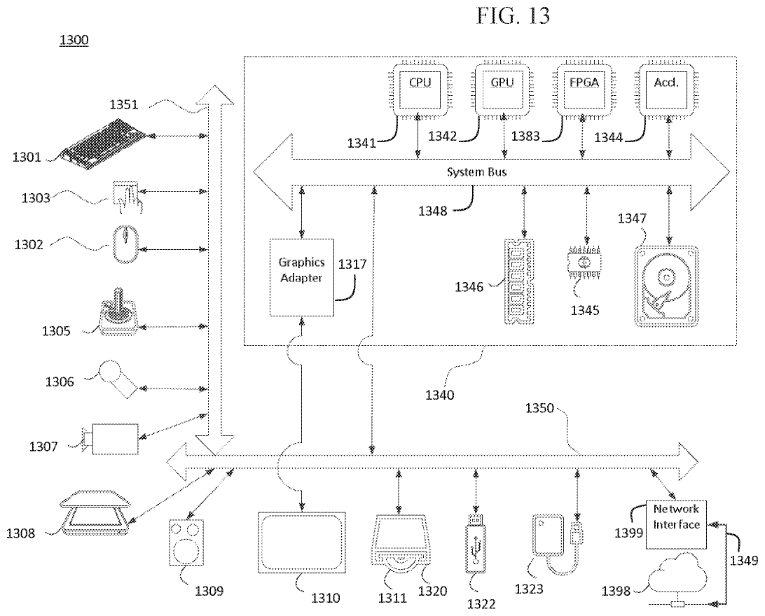

The techniques for Extending video NAL units for SEI messages, described above, can be implemented as computer software using computer-readable instructions and physically stored in one or more computer-readable media. For example, FIG. 13 shows a computer system 1300 suitable for implementing certain embodiments of the disclosed subject matter.

The techniques described above, can be implemented as computer software using computer-readable instructions and physically stored in one or more computer-readable media or by a specifically configured one or more hardware processors. For example, FIG. 13 shows a computer system 1300 suitable for implementing certain embodiments of the disclosed subject matter.

The techniques described above, can be implemented as computer software using computer-readable instructions and physically stored in one or more computer-readable media or by a specifically configured one or more hardware processors. For example, FIG. 13 shows a computer system 1300 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 13 for computer system 1300 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 1300.

Computer system 1300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 1301, mouse 1302, trackpad 1303, touch screen 1310, joystick 1305, microphone 1306, scanner 1308, camera 1307.

Computer system 1300 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1310, or joystick 1305, but there can also be tactile feedback devices that do not serve as input devices), audio output devices (such as: speakers 1309, headphones (not depicted)), visual output devices (such as screens 1310 to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system 1300 can also include human accessible storage devices and their associated media such as optical media including CD/DVD ROM/RW 1320 with CD/DVD 1311 or the like media, thumb-drive 1322, removable hard drive or solid state drive 1323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1300 can also include interface 1399 to one or more communication networks 1398. Networks 1398 can for example be wireless, wireline, optical. Networks 1398 can further be local, wide-area, metropolitan, vehicular and industrial, real-time, delay-tolerant, and so on. Examples of networks 1398 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 1398 commonly require external network interface adapters that attached to certain general-purpose data ports or peripheral buses (1350 and 1351) (such as, for example USB ports of the computer system 1300; others are commonly integrated into the core of the computer system 1300 by attachment to a system bus as described below (for example Ethernet interface into a PC computer system or cellular network interface into a smartphone computer system). Using any of these networks 1398, computer system 1300 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1340 of the computer system 1300.

The core 1340 can include one or more Central Processing Units (CPU) 1341, Graphics Processing Units (GPU) 1342, a graphics adapter 1317, specialized programmable processing units in the form of Field Programmable Gate Areas (FPGA) 1343, hardware accelerators for certain tasks 1344, and so forth. These devices, along with Read-only memory (ROM) 1345, Random-access memory 1346, internal mass storage such as internal non-user accessible hard drives, SSDs, and the like 1347, may be connected through a system bus 1348. In some computer systems, the system bus 1348 can be accessible in the form of one or more physical plugs to enable extensions by additional CPUs, GPU, and the like. The peripheral devices can be attached either directly to the core's system bus 1348, or through a peripheral bus 1349. Architectures for a peripheral bus include PCI, USB, and the like.

CPUs 1341, GPUs 1342, FPGAs 1343, and accelerators 1344 can execute certain instructions that, in combination, can make up the aforementioned computer code. That computer code can be stored in ROM 1345 or RAM 1346. Transitional data can be also be stored in RAM 1346, whereas permanent data can be stored for example, in the internal mass storage 1347. Fast storage and retrieval to any of the memory devices can be enabled through the use of cache memory, that can be closely associated with one or more CPU 1341, GPU 1342, mass storage 1347, ROM 1345, RAM 1346, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 1300, and specifically the core 1340 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1340 that are of non-transitory nature, such as core-internal mass storage 1347 or ROM 1345. The software implementing various embodiments of the present disclosure can be stored in such devices and executed by core 1340. A computer-readable medium can include one or more memory devices or chips, according to particular needs. The software can cause the core 1340 and specifically the processors therein (including CPU, GPU, FPGA, and the like) to execute particular processes or particular parts of particular processes described herein, including defining data structures stored in RAM 1346 and modifying such data structures according to the processes defined by the software. In addition or as an alternative, the computer system can provide functionality as a result of logic hardwired or otherwise embodied in a circuit (for example: accelerator 1344), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for video decoding, the method performed by at least one processor and comprising:
obtaining at least one first network abstraction layer (NAL) unit that comprises information of a decoding processing;
identifying a presence of a supplementary enhancement information (SEI) extension to the at least one first NAL unit;
parsing the at least one first NAL unit and the SEI extension; and
based on the SEI extension, decoding video data.

2. The method according to claim 1,
wherein the at least one first NAL unit is one of a video usability information, a video parameter set, a sequence parameter set, a picture parameter set, and an adaptation parameter set.

3. The method according to claim 1,
wherein the SEI extension comprises an SEI_rbsp( ) syntax.

4. The method according to claim 1,
wherein the SEI extension is of one of a coded video stream and a coded layer video stream.

5. The method according to claim 1,
wherein the SEI extension indicates at least one of a two-dimensional (2D) omnidirectional presentation and a 2D presentation.

6. The method according to claim 1,
wherein the SEI extension indicates at least one of an interpretation of color and light and a picture capturing process.

7. The method according to claim 1,
wherein the SEI extension indicates at least one of random access points and descriptions of a coded layer video stream.

8. A method for video encoding, the method performed by at least one processor and comprising:
determining at least one first network abstraction layer (NAL) unit that comprises information of a decoding processing;
adding a supplementary enhancement information (SEI) extension to the at least one first NAL unit; and
based on the SEI extension, encoding video data.

9. The method according to claim 8,
wherein the at least one first NAL unit is one of a video usability information, a video parameter set, a sequence parameter set, a picture parameter set, and an adaptation parameter set.

10. The method according to claim 8,
wherein the SEI extension comprises an SEI_rbsp( ) syntax.

11. The method according to claim 8,
wherein the SEI extension is of one of a coded video stream and a coded layer video stream.

12. The method according to claim 8,
wherein the SEI extension indicates at least one of a two-dimensional (2D) omnidirectional presentation and a 2D presentation.

13. The method according to claim 8,
wherein the SEI extension indicates at least one of an interpretation of color and light and a picture capturing process.

14. The method according to claim 8,
wherein the SEI extension indicates at least one of random access points and descriptions of a coded layer video stream.

15. A non-transitory computer-readable storage medium storing instructions and a video bitstream that are generated by a video encoding method, the instructions, when executed by a computer, cause the computer to implement a video encoding method comprising:
determining at least one first network abstraction layer (NAL) unit that comprises information of a decoding processing;
adding a supplementary enhancement information (SEI) extension to the at least one first NAL unit;
based on the SEI extension, encoding video data; and
transmitting the video bitstream.

16. The method according to claim 15,
wherein the at least one first NAL unit is one of a video usability information, a video parameter set, a sequence parameter set, a picture parameter set, and an adaptation parameter set.

17. The method according to claim 15,
wherein the SEI extension comprises an SEI_rbsp( ) syntax.

18. The method according to claim 15,
wherein the SEI extension is of one of a coded video stream and a coded layer video stream.

19. The method according to claim 15,
wherein the SEI extension indicates at least one of a two-dimensional (2D) omnidirectional presentation and a 2D presentation.

20. The method according to claim 15,
wherein the SEI extension indicates at least one of an interpretation of color and light, a picture capturing process, random access points, descriptions of a coded layer video stream.
